(19) United States
(12) Patent Application Publication
(10) Pub. No.: US 2020/0260507 A1
(43) Pub. Date: Aug. 13, 2020

(54) IN-VEHICLE COMMUNICATION SYSTEM

(71) Applicant: TOYOTA JIDOSHA KABUSHIKI KAISHA, Toyota-shi (JP)

(72) Inventor: Kazuki MATSUMOTO, Ogaki-shi (JP)

(73) Assignee: TOYOTA JIDOSHA KABUSHIKI KAISHA, Toyota-shi (JP)

(21) Appl. No.: 16/731,142

(22) Filed: Dec. 31, 2019

(30) Foreign Application Priority Data
Feb. 8, 2019 (JP) 2019-021449

(51) Int. Cl. H04W 76/11; H04W 76/18; H04W 4/48; H04W 4/44; H04W 4/029; H04B 1/54

(52) U.S. Cl. CPC H04W 76/11; H04W 76/18; H04B 1/54; H04W 4/44; H04W 4/029; H04W 4/48

(57) ABSTRACT

An in-vehicle communication system can communicate with a public communication network through the use of communication modules, and can use, as the communication modules, an in-vehicle communication module that is mounted in a vehicle and an outside communication module other than the in-vehicle communication module. The in-vehicle communication system is equipped with a communication state confirmation unit that transmits data to the public communication network and receives data from the public communication network through the use of the outside communication module, and that confirms a communication state between the outside communication module and the public communication network, and a module selection unit that selects the communication module to be used, from between the in-vehicle communication module and the outside communication module, based on the communication state confirmed by the communication state confirmation unit.

### INCORPORATION BY REFERENCE

The disclosure of Japanese Patent Application No. 2019-021449 filed on Feb. 8, 2019 including the specification, drawings and abstract is incorporated herein by reference in its entirety.

### BACKGROUND

### 1. Technical Field

The disclosure relates to an in-vehicle communication system.

### 2. Description of Related Art

An in-vehicle communication system mounted in a vehicle can communicate with a public communication network through the use of a communication module. As the communication module, an in-vehicle communication module that is mounted in the vehicle, such as a data communication module (DCM) or the like, and an outside communication module that has been brought in from outside the vehicle, such as a mobile router that can be connected via Wi-Fi, USB etc., or the like can be used (see Japanese Patent Application Publication No. 2016-45710 (JP 2016-45710 A) and Japanese Patent Application Publication No. 2014-123843 (JP 2014-123843 A)).

### SUMMARY

However, the in-vehicle communication system may not be able to grasp a communication state between the outside communication module and the public communication network, due to an adopted protocol and an adopted communication module type. In this case, communication may become impossible when the outside communication module is used. As a result, the in-vehicle communication system lacks stability in communicating with the public communication network.

The disclosure has been made in view of the foregoing. It is an object of the disclosure to provide an in-vehicle communication system that can stably communicate with a public communication network through the use of a communication module.

An in-vehicle communication system according to one aspect of the disclosure is an in-vehicle communication system that can communicate with a public communication network through the use of communication modules, and that can use, as the communication modules, an in-vehicle communication module that is mounted in a vehicle and an outside communication module other than the in-vehicle communication module. The in-vehicle communication system is equipped with a communication state confirmation unit that transmits data to the public communication network or receives data from the public communication network through the use of the outside communication module, and that confirms a communication state between the outside communication module and the public communication network, and a module selection unit that selects the communication module to be used, from between the in-vehicle communication module and the outside communication module, based on the communication state confirmed by the communication state confirmation unit.

In the aforementioned aspect, the communication state confirmation unit may estimate an electric field intensity between the outside communication module and the public communication network based on a result of transmission or reception of the data, and confirm a communication state through the use of the electric field intensity.

In the aforementioned aspect, the module selection unit may select the in-vehicle communication module on a priority basis, and select the outside communication module when a predetermined condition is satisfied.

In the aforementioned aspect, the module selection unit may select the outside communication module when a communication speed of the outside communication module is higher than a communication speed of the in-vehicle communication module.

In the aforementioned aspect, the module selection unit may select the outside communication module when a user desires to use the outside communication module.

In the aforementioned aspect, the module selection unit may select the communication module further in accordance with a user's desire.

In the aforementioned aspect, the module selection unit may select the communication module further based on positional information on the vehicle.

In the aforementioned aspect, the module selection unit may select the communication module based on the positional information on the vehicle, and usable area information on a mobile communication system of a generation in which each of the communication modules can be used.

According to the disclosure, it is possible to provide an in-vehicle communication system that can stably communicate with a public communication network through the use of a communication module.

### BRIEF DESCRIPTION OF THE DRAWINGS

Features, advantages, and technical and industrial significance of an exemplary embodiment of the disclosure will be described below with reference to the accompanying drawings, in which like numerals denote like elements, and wherein:

FIG. 1 is an illustrative view showing the outline of the configuration of a communication system including an in-vehicle communication system;

FIG. 2 is a block diagram showing a configurational example of a control device of the in-vehicle communication system;

FIG. 3 is a table showing an exemplary corresponding relationship between success and failure of communication by communication applications and a result of determination on an electric field intensity;

FIG. 4 is a block diagram showing another configurational example of the control device of the in-vehicle communication system;

FIG. 5 is a table showing a condition desired by a user; and

FIG. 6 is a view showing the flow of selecting a communication module.

### DETAILED DESCRIPTION OF EMBODIMENT

The embodiment of the disclosure will be described hereinafter in detail. Incidentally, the following embodiment is an exemplification for illustrating the disclosure, and is not intended to limit the disclosure thereto. Furthermore, the disclosure can be subjected to various modifications without departing from the gist thereof.

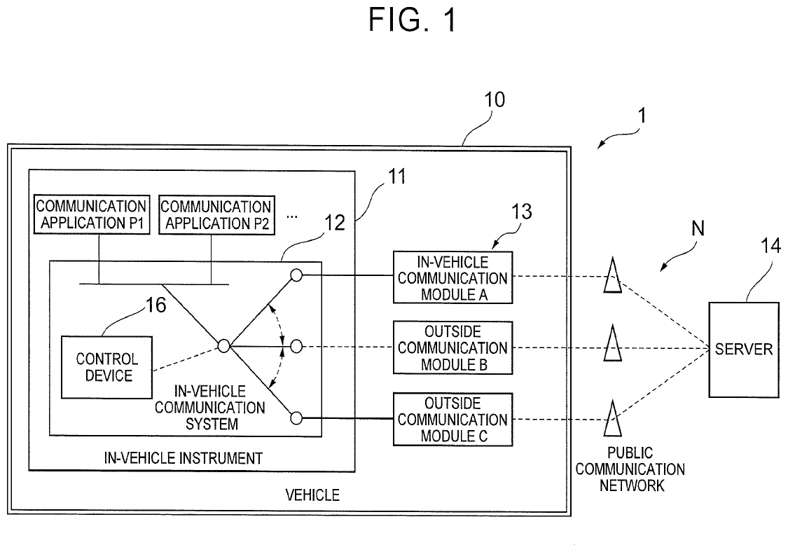

FIG. 1 shows an exemplary configuration of a communication system 1 having an in-vehicle communication system according to the present embodiment. The communication system 1 includes an in-vehicle communication system 12 of an in-vehicle instrument 11 mounted in a vehicle 10, a communication module group 13, and a public communication network N.

The in-vehicle communication system 12 can communicate with the public communication network N through the use of a plurality of later-described communication modules of the communication module group 13.

The communication module group 13 is composed of the plurality of the communication modules, and is equipped with, for example, an in-vehicle communication module A that is mounted in the vehicle 10, and communication modules other than the in-vehicle communication module A, for example, outside communication modules B and C that have been brought in from the outside of the vehicle 10.

The in-vehicle communication module A is, for example, a data communication module (DCM) as an in-vehicle instrument. The outside communication module B is, for example, a router that can establish communication through the use of Wi-Fi connection (wireless connection). The outside communication module C is, for example, a router that can establish communication through the use of USB connection (wired connection).

The public communication network N is equipped with an outside server 14. The outside server 14 has the function of transmitting/receiving data.

The in-vehicle instrument 11 equipped with the in-vehicle communication system 12 is equipped with one or more communication applications for transmitting/receiving certain dedicated data to/from the outside server 14 of the public communication network N. In the present embodiment, the in-vehicle instrument 11 is equipped with a plurality of communication applications, for example, two communication applications P1 and P2. For example, the communication applications P1 and P2 are stored in a storage unit (not shown) of the in-vehicle instrument 11. Incidentally, the communication applications P1 and P2 may be stored in the in-vehicle communication system 12.

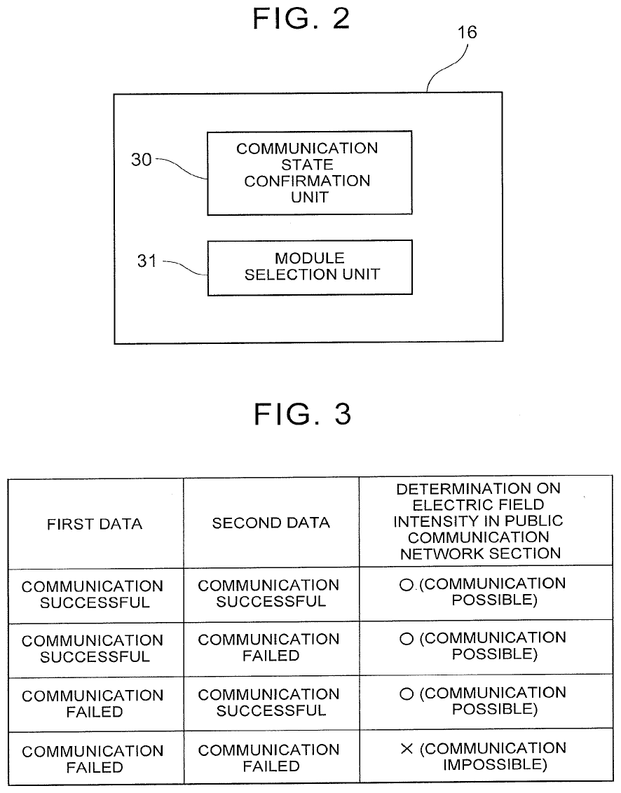

The in-vehicle communication system 12 is equipped with a control device 16. The control device 16 is equipped, as its functional configuration, with, for example, a communication state confirmation unit 30 and a module selection unit 31, as shown in FIG. 2. The control device 16 is configured to be equipped, as its physical configuration, with, for example, a control unit including a central processing unit (CPU) and a memory, an operation portion, a display, a speaker, a storing unit, a communication unit, and the like. The respective functions of the communication state confirmation unit 30, the module selection unit 31, and the like are developed through the execution of a predetermined program stored in the memory by the CPU.

The communication state confirmation unit 30 transmits/receives data to/from the public communication network N through the use of the outside communication modules B and C, and confirms a communication state between each of the outside communication modules B and C and the public communication network N. For example, the communication state confirmation unit 30 transmits/receives Ping-based dedicated data from/by the outside communication modules B and C to/from the outside server 14 through the use of the communication application P1. Besides, the communication state confirmation unit 30 transmits/receives, for example, HTTP communication-based dedicated data from/by the outside communication modules B and C to/from the outside server 14 through the use of the communication application P2. The communication state confirmation unit 30 periodically transmits/receives these dedicated data.

The communication state confirmation unit 30 confirms an electric field intensity as the communication state, based on a result of transmission/reception of the dedicated data. In concrete terms, the communication state confirmation unit 30 transmits/receives two types of dedicated data, namely, Ping-based dedicated data and HTTP communication-based dedicated data as to each of the outside communication modules B and C. When communication of both the types of dedicated data fails, the communication state confirmation unit 30 estimates that the electric field intensity of communication through the use of the outside communication module is lower than a predetermined threshold, and hence confirms that the electric field intensity is absent or insufficient (communication is impossible). Besides, when communication of one of both the types of dedicated data is successful, the communication state confirmation unit 30 estimates that the electric field intensity of communication through the use of the outside communication module is equal to or higher than the predetermined threshold, and hence confirms that the electric field intensity is sufficient (communication is possible). An exemplary corresponding relationship between success/failure of communication based on each of Ping-based dedicated data (first data) and HTTP communication-based dedicated data (second data) and the result of determination on the electric field intensity of a section of the public communication network N is described in FIG. 3.

The module selection unit 31 selects the communication module to be used from among the in-vehicle communication module A and the outside communication modules B and C, based on the communication state confirmed by the communication state confirmation unit 30.

For example, when both the outside communication modules B and C cannot establish communication due to an insufficiency of the electric field intensity, the module selection unit 31 selects the in-vehicle communication module A as the communication module to be used. When one of the outside communication modules B and C can establish communication, the module selection unit 31 selects the communication module to be used from between the outside communication module that can establish communication and the in-vehicle communication module A. When both the outside communication modules B and C can establish communication, the module selection unit 31 selects the communication module to be used from among the two outside communication modules B and C and the in-vehicle communication module A.

In the case where the communication module to be used can be selected from among the plurality of the communication modules, the module selection unit 31 may select the communication module that can be estimated to exhibit the highest electric field intensity, the communication module with high communication speed, the communication module that suits the user's desire, the communication module with low communication cost, or the like, from among the plurality of the communication modules. For example, in the case where the outside communication modules B and C and the in-vehicle communication module A can be selected, the module selection unit 31 selects the outside communication module B when the communication speed of the outside communication module B is the highest.

According to the present embodiment, the in-vehicle communication system 12 is equipped with the communication state confirmation unit 30 that transmits/receives data to/from the outside server 14 of the public communication network N through the use of the outside communication modules B and C and that confirms the communication state between each of the outside communication modules B and C and the public communication network N, and the module selection unit 31 that selects the communication module to be used from among the in-vehicle communication module A and the outside communication modules B and C based on the communication state confirmed by the communication state confirmation unit 30. Thus, the communication state between each of the outside communication modules B and C and the public communication network N can be grasped, and the communication module to be used can be selected, based on the grasped result, from among the communication modules A, B, and C including the in-vehicle communication module A. Therefore, in the in-vehicle communication system 12, communication with the public communication network N through the use of the communication modules A, B, and C can be stably established.

The communication state confirmation unit 30 estimates the electric field intensity based on the result of transmission/reception of data, and confirms the communication state through the use of the electric field intensity. Therefore, an exact and appropriate determination on the communication state of each of the outside communication modules B and C can be made. In particular, the communication state confirmation unit 30 confirms the electric field intensity based on the result of transmission/reception of a plurality of types of data. Therefore, a more exact and appropriate determination on the communication state of each of the outside communication modules B and C can be made.

In the foregoing embodiment, the module selection unit 31 may select the communication module further based on positional information on the vehicle 10. For example, the in-vehicle communication system 12 holds (stores) in advance a map where priorities of the communication modules are registered for each geographical area. The priority of each of these communication modules may be set in advance based on a cover area or the like of a communication service of each of the communication modules, or may be set according to the user's desire. The module selection unit 31 may select the communication module registered in the map and exhibiting high priority, from among the outside communication modules B and C and the in-vehicle communication module A, which can establish communication and have been confirmed by the communication state confirmation unit 30, while acquiring positional information from the vehicle 10. At this time, positional information acquired by a navigation system of the vehicle 10 may be used as the positional information on the vehicle 10. In this case, the communication module can be selected in consideration of the positional information on the vehicle 10. Therefore, in the in-vehicle communication system 12, more stable communication can be established through the use of the communication modules A, B, and C.

Furthermore, the module selection unit 31 may select the communication module to be used, based on the positional information on the vehicle 10 and usable area information on a mobile communication system of a generation in which each of the communication modules can be used. For example, in the case where there are a usable area of a third-generation mobile communication system (3G), a usable area of a fourth-generation mobile communication system (4G), and a usable area of a fifth-generation mobile communication system (5G) for each of the communication modules A, B, and C, the module selection unit 31 may select the communication module that makes it possible to use the mobile communication system of a later generation (a generation with high communication speed) at the position of the vehicle 10, from among the outside communication modules B and C and the in-vehicle communication module A, which can establish communication and have been confirmed from the positional information on the vehicle 10 and by the communication state confirmation unit 30. For example, in the case where 5G can be used in the in-vehicle communication module A and 4G can be used in the outside communication modules B and C at the position of the vehicle 10, the in-vehicle communication module A is selected. In this case, in the in-vehicle communication system 12, higher-speed, more comfortable communication can be established through the use of the communication modules A, B, and C.

Besides, in the foregoing embodiment, the module selection unit 31 may select the in-vehicle communication module A on a priority basis when the communication state of each of the outside communication modules is good, and may select the outside communication modules when a predetermined condition is satisfied. For example, the outside communication modules may be selected only when, for example, the communication speed of each of the outside communication modules is higher than the communication speed of the in-vehicle communication module A. Otherwise, the in-vehicle communication module may be selected. In this case, the communication state of the in-vehicle communication module A is more stable than the communication state of each of the outside communication modules B and C. Therefore, stable communication of the in-vehicle communication system 12 can be ensured. Incidentally, the outside communication modules may be selected only when each of the outside communication modules satisfies a predetermined condition on the communication cost or the electric field intensity, instead of the communication speed.

Furthermore, the module selection unit 31 may select the outside communication modules when the user desires to use the outside communication modules. The user may desire to use the outside communication modules when the user inputs information on his or her desire to use the outside communication modules to, for example, the in-vehicle communication system 12, or when the user's desire to use the outside communication modules is registered in advance in the in-vehicle communication system 12. In this case, the communication module in a good communication state can be stably used while satisfying the user's desire.

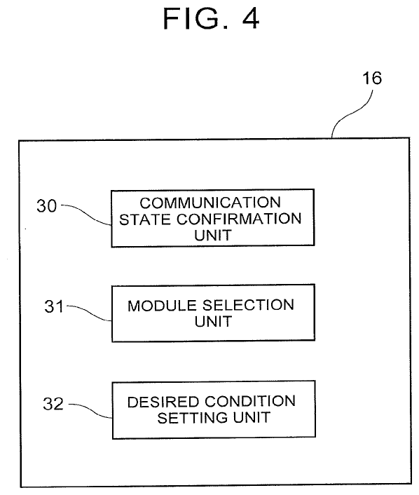

Subsequently, in the aforementioned embodiment, the module selection unit 31 may select the communication module further in accordance with the user's desire. In this case, for example, the control device 16 of the in-vehicle communication system 12 is equipped, as its functional configuration, with a desired condition setting unit 32 as well as the communication state confirmation unit 30 and the module selection unit 31, as shown in FIG. 4.

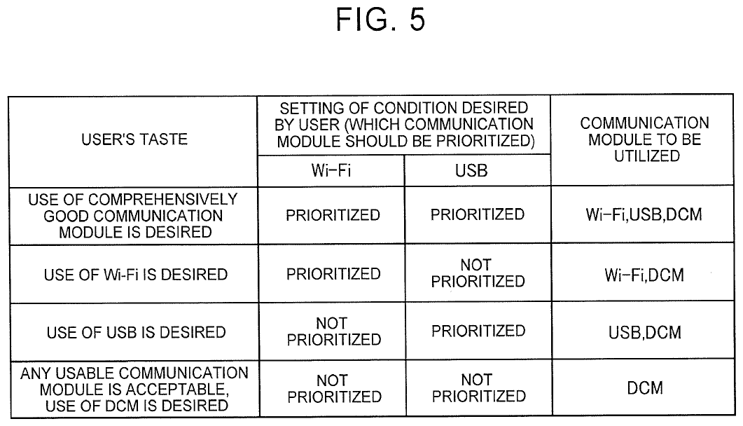

The desired condition setting unit 32 sets a condition desired by the user as to each of the communication modules A, B, and C to be used. For example, the desired condition setting unit 32 sets the condition desired by the user, such as which one of the communication modules should be prioritized, based on information on the user's taste as shown in FIG. 5, which has been input from, for example, an input unit (not shown) of the control device 16.

For example, in the case where the user's taste reflects “a desire to use a comprehensively good communication module” or the like, prioritization of the Wi-Fi outside communication module B and the USB outside communication module C is set as a condition (1) desired by the user. In the case where the user's taste reflects “a desire to use Wi-Fi” or the like, prioritization of the Wi-Fi outside communication module B and non-prioritization of the USB outside communication module C are set as a condition (2) desired by the user. In the case where the user's taste reflects “a desire to use USB” or the like, non-prioritization of the Wi-Fi outside communication module B and prioritization of the USB outside communication module C are set as a condition (3) desired by the user. Furthermore, in the case where the user's taste reflects “an intention to accept any usable communication module”, “a desire to use DCM (the in-vehicle communication module A)” or the like, non-prioritization of the Wi-Fi outside communication module B and the USB outside communication module C is set as a condition (4) desired by the user. Incidentally, the user's taste (what the user desires to use) may be input by the user as described above, or may be registered in advance.

The module selection unit 31 selects the communication module to be used from among the in-vehicle communication module A and the outside communication modules B and C, based on the desired condition set by the desired condition setting unit 32 and the communication state confirmed by the communication state confirmation unit 30. In this case, the communication module in a good communication state can be stably used while satisfying the user's desire.

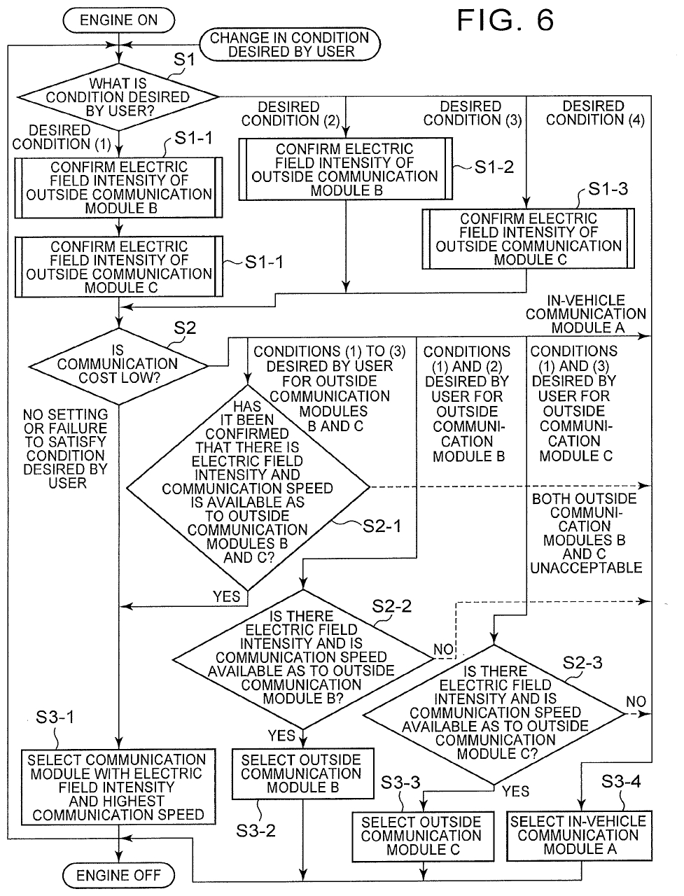

In the foregoing embodiment, the module selection unit 31 may select the communication module comprehensively taking into account the condition desired by the user, the electric field intensity, the communication speed, the communication cost, and the like. An example of this case will be described hereinafter. FIG. 6 is a view showing the processing flow for selecting the communication module according to this example. As the condition desired by the user, the above-mentioned conditions (1), (2), (3) and (4) desired by the user as described with reference to FIG. 5 are used.

First of all, when an electric power supply (an engine) of the vehicle is turned on, the electric field intensity as the communication state of the communication module is confirmed based on the condition desired by the user, which has been set by the desired condition setting unit 32 (step S1).

Incidentally, when the electric power supply of the vehicle is turned on as shown in FIG. 6, the condition desired by the user may be changed. In this case, the electric field intensity of the communication module is confirmed based on the changed condition desired by the user.

For example, when the desired condition setting unit 32 sets the desired condition (1), the communication state confirmation unit 30 first confirms the electric field intensity as to each of the Wi-Fi outside communication module B and the USB outside communication module C. The communication state confirmation unit 30 transmits/receives two types of data of the communication applications P1 and P2 to/from the outside server 14 via the outside communication modules B and C respectively, and confirms, based on a result of transmission/reception, whether or not the electric field intensity of each of the outside communication modules B and C is equal to or higher than a predetermined threshold (step S1-1). Incidentally, this electric field intensity is confirmed by transmitting/receiving the two types of dedicated data, namely, Ping-based dedicated data and HTTP communication-based dedicated data as to each of the outside communication modules B and C. When communication of both the types of dedicated data fails, the electric field intensity is regarded as lower than the predetermined threshold. When communication of one of the two types of dedicated data is successful, the electric field intensity of communication through the use of the outside communication module is regarded as equal to or higher than the predetermined threshold.

When the desired condition setting unit 32 sets the desired condition (2), the communication state confirmation unit 30 confirms the electric field intensity as to the Wi-Fi outside communication module B. The communication state confirmation unit 30 transmits/receives the two types of data of the communication applications P1 and P2 to/from the outside server 14 via the outside communication module B, and confirms, based on a result of transmission/reception, whether or not the electric field intensity of the outside communication module B is equal to or higher than the predetermined threshold (step S1-2).

When the desired condition setting unit 32 sets the desired condition (3), the communication state confirmation unit 30 confirms the electric field intensity as to the outside communication module C. The communication state confirmation unit 30 transmits/receives the two types of data of the communication applications P1 and P2 to/from the outside server 14 via the outside communication module C, and confirms, as a result of transmission/reception, whether or not the electric field intensity of the outside communication module C is equal to or higher than the predetermined threshold (step S1-3).

When the desired condition setting unit 32 sets the desired condition (4), the module selection unit 31 selects the in-vehicle communication module A (step S3-4).

Subsequently, the module selection unit 31 selects the communication module based on the communication cost, the electric field intensity, and the communication speed (step S2).

For example, in the case where the communication costs of both the outside communication modules B and C are low, the aforementioned desired conditions (1), (2), and (3) are applicable, and it is confirmed whether or not the electric field intensity is equal to or higher than the predetermined threshold, and whether or not the communication speed is equal to or higher than the predetermined threshold, as to both the outside communication module B and the outside communication module C (step S2-1). At this time, the electric field intensity and the communication speed are confirmed as to the outside communication modules B and C, more specifically, first as to the communication module that is connected to the in-vehicle communication system 12 later and then as to the other communication module. In the case of the desired condition (1) (the outside communication modules B and C are prioritized), when both the outside communication modules B and C satisfy the conditions of the electric field intensity and the communication speed, the communication module with the higher communication speed is selected (step S3-1). When both the outside communication modules B and C do not satisfy the conditions of the electric field intensity and the communication speed, the in-vehicle communication module A is selected (step S3-4). When only one of the outside communication modules B and C satisfies the conditions, the outside communication module satisfying the conditions is selected (step S3-1). In the case of the desired condition (2) (the outside communication module B is prioritized), when the outside communication module B satisfies the conditions of the electric field intensity and the communication speed, the outside communication module B is selected (step S3-2). In this case, when the outside communication module B does not satisfy the conditions, the in-vehicle communication module A is selected (step S3-4). By the same token, in the case of the desired condition (3) (the outside communication module C is prioritized), when the outside communication module C satisfies the conditions of the electric field intensity and the communication speed, the outside communication module C is selected (step S3-3). In this case, when the outside communication module C does not satisfy the conditions, the in-vehicle communication module A is selected (step S3-4).

In the case where the communication cost of the outside communication module B is low, the aforementioned desired conditions (1) and (2) are applicable, and it is confirmed whether or not the electric field intensity is equal to or higher than the predetermined threshold, and whether or not the communication speed is equal to or higher than the predetermined threshold, as to the outside communication module B (step S2-2). Then, in the cases of the desired condition (1) (the outside communication modules B and C are prioritized) and the desired condition (2) (the outside communication module B is prioritized), when the outside communication module B satisfies the conditions of the electric field intensity and the communication speed, the outside communication module B is selected (step S3-2). In these cases, when the outside communication module B does not satisfy the conditions, the in-vehicle communication module A is selected (step S3-4).

In the case where the communication cost of the outside communication module C is low, the aforementioned desired conditions (1) and (3) are applicable, and it is confirmed whether or not the electric field intensity is equal to or higher than the predetermined threshold, and whether or not the communication speed is equal to or higher than the predetermined threshold, as to the outside communication module C (step S2-3). Then, in the cases of the desired condition (1) (the outside communication modules B and C are prioritized) and the desired condition (3) (the outside communication module C is prioritized), when the outside communication module C satisfies the conditions of the electric field intensity and the communication speed, the outside communication module C is selected (step S3-3). In these cases, when the outside communication module C does not satisfy the conditions, the in-vehicle communication module A is selected (step S3-4).

In the case where the communication cost of the in-vehicle communication module A is low, the in-vehicle communication module A is selected (step S3-4).

In the case where no communication module with low communication cost is set or the communication module with low communication cost does not satisfy the desired conditions (1), (2), and (3), the communication module with the electric field intensity equal to or higher than the predetermined threshold and with the highest communication speed is selected from among the outside communication modules B and C and the in-vehicle communication module A (step S3-1). Incidentally, in the case where the communication module with low communication cost does not satisfy the desired conditions (1), (2), and (3), the in-vehicle communication module A may be selected.

The aforementioned steps S1, S2, and S3 are repeated on a certain cycle until the engine is turned OFF.

According to this example, the communication module that is excellent in communication stability, communication speed, and communication cost can be used in view of the user's taste, comprehensively taking into account the condition desired by the user, the electric field intensity, the communication speed, and the communication cost.

Incidentally, the disclosure is not limited to the foregoing embodiment, but can be carried out in various other forms within such a range as not to depart from the gist of the disclosure. Accordingly, the aforementioned embodiment is nothing more than an exemplification in all respects, and should not be construed in a restrictive manner.

For example, the dedicated data that are transmitted/received from/by the in-vehicle communication system 12 to/from the outside server 14 are not necessarily based on the communication applications of the aforementioned example. The types of communication modules and the number of communication modules are not limited to those in the aforementioned embodiment either.

Besides, the components of the in-vehicle communication system 12, the control device 16, the outside server 14, and the like are not limited to the components in the foregoing embodiment, but any components can be appropriately added thereto if necessary.

The disclosure is useful in providing an in-vehicle communication system that can stably communicate with a public communication network through the use of a communication module.

What is claimed is:

1. An in-vehicle communication system that can communicate with a public communication network through use of communication modules, and that can use, as the communication modules, an in-vehicle communication module that is mounted in a vehicle and an outside communication module other than the in-vehicle communication module, comprising:
a communication state confirmation unit that transmits data to the public communication network and receives data from the public communication network through use of the outside communication module, and that confirms a communication state between the outside communication module and the public communication network; and
a module selection unit that selects the communication module to be used, from between the in-vehicle communication module and the outside communication module, based on the communication state confirmed by the communication state confirmation unit.

2. The in-vehicle communication system according to claim 1, wherein
the communication state confirmation unit estimates an electric field intensity between the outside communication module and the public communication network based on a result of transmission or reception of the data, and confirms a communication state of the outside communication module through use of the electric field intensity.

3. The in-vehicle communication system according to claim 1, wherein
the module selection unit selects the in-vehicle communication module on a priority basis, and selects the outside communication module when a predetermined condition is satisfied.

4. The in-vehicle communication system according to claim 3, wherein
the module selection unit selects the outside communication module when a communication speed of the outside communication module is higher than a communication speed of the in-vehicle communication module.

5. The in-vehicle communication system according to claim 3, wherein
the module selection unit selects the outside communication module when a user desires to use the outside communication module.

6. The in-vehicle communication system according to claim 1, wherein
the module selection unit selects the communication module further in accordance with a user's desire.

7. The in-vehicle communication system according to claim 1, wherein
the module selection unit selects the communication module further based on positional information on the vehicle.

8. The in-vehicle communication system according to claim 7, wherein
the module selection unit selects the communication module based on the positional information on the vehicle, and usable area information on a mobile communication system of a generation in which each of the communication modules can be used.
